(19) United States
(12) Patent Application Publication
(10) Pub. No.: US 2022/0248092 A1
(43) Pub. Date: Aug. 4, 2022

(54) VIDEO DISPLAY SYSTEM, INFORMATION PROCESSING DEVICE, VIDEO DISPLAY DEVICE, VIDEO DISPLAY METHOD, AND PROGRAM

(71) Applicant: Sharp NEC Display Solutions, Ltd., Tokyo (JP)

(72) Inventor: Takashi MIKURIYA, Tokyo (JP)

(21) Appl. No.: 17/617,634

(22) PCT Filed: Jun. 13, 2019
(86) PCT No.: PCT/JP2019/023408

§ 371 Date: Dec. 9, 2021

(51) Int. Cl. H04N 21/462; H04N 21/258

(52) U.S. Cl. CPC H04N 21/462; H04N 21/25825

(57) ABSTRACT

An information processing device includes: an acquisitioner configured to acquire a video to be displayed from image data that is transmitted to a video display device; a storage configured to store the acquired video; a transmitter configured to transmit the image data to the video display device; a receiver configured to receive a display completion notification transmitted from the video display device in response to the video having been displayed; and a display configured to read the video corresponding to the display completion notification received by the receiver from the storage and display the video.

### TECHNICAL FIELD

The present invention relates to a video display system, an information processing device, a video display device, a video display method, and a program.

### BACKGROUND ART

There is technology for connecting an information processing device and a video display device via a network such as a wireless local area network (LAN), transmitting an image to the video display device through an application program of the information processing device, and displaying the image on the video display device (for example, Patent Literature 1). The information processing device captures a currently output video as a single image, scales the image at the optimum resolution for displaying the video on the video display device, and transmits image data to the video display device through network communication after an encoding process of optimizing an amount of information suitable for image transmission is performed. After receiving the image data, the video display device decodes and restores the image data, and displays the image through a video display process.

### CITATION LIST

### Patent Literature

### [Patent Literature 1]

Japanese Unexamined Patent Application, First Publication No. 2010-147905

### SUMMARY OF INVENTION

### Technical Problem

Because a processing time period is required for a series of flows from a timing when the information display device captures an image to a timing when the video display device displays the image, a video to be displayed by the video display device according to image transmission is displayed at a timing later than that of the video output by the information processing device. Thus, in a case in which a presenter is giving a presentation while viewing a video output from the information processing device and the like, the presenter may not be aware of what video the audience can view, i.e., what video is displayed by a video display device, and may explain content different from that being displayed by the video display device.

In view of the above problems, an objective of the present invention is to provide an information processing device, a video display device, a display system, a video display method, and a program capable of enabling content of a video displayed by a video display device to be ascertained at an information processing device side when image data from an information processing device is transmitted to the video display device and displayed on the video display device.

### Solution to Problem

An information processing device according to one aspect of the present invention includes: an acquisitioner configured to acquire a video to be displayed from image data that is transmitted to a video display device; a storage configured to store the acquired video; a transmitter configured to transmit the image data to the video display device; a receiver configured to receive a display completion notification transmitted from the video display device in response to the video having been displayed; and a display configured to read the video corresponding to the display completion notification received by the receiver from the storage and display the video.

A video display device according to one aspect of the present invention includes: a receiver configured to receive image data from an information processing device; a display configured to display a video based on the image data received from the information processing device; and a transmitter configured to transmit a display completion notification to the information processing device in response to the video having been displayed.

A video display system according to one aspect of the present invention includes an information processing device and a video display device for displaying a video from the information processing device, wherein the information processing device includes: an acquisitioner configured to acquire a video to be displayed from image data that is transmitted to the video display device; a storage configured to store the acquired video; a first transmitter configured to transmit the image data to the video display device; a first receiver configured to receive a display completion notification transmitted from the video display device in response to the video having been displayed; and a first display configured to read the video corresponding to the received display completion notification from the storage and display the video, and wherein the video display device includes: a second receiver configured to receive the image data from the information processing device; a second display configured to display the video based on the image data received from the information processing device; and a second transmitter configured to transmit the display completion notification to the information processing device in response to the video having been displayed.

In an image display method, according to the present invention, to be performed by an information processing device when image data is transmitted from the information processing device and displayed on a video display device, the image display method includes processes of: acquiring a video to be displayed from the image data that is transmitted to the video display device; storing the acquired video in a storage; transmitting the image data to the video display device; and reading, in case that a display completion notification transmitted from the video display device in response to the video having been displayed is received, the video corresponding to the received display completion notification from the storage and displaying the video.

In an image display method, according to the present invention, to be performed by a video display device when image data is transmitted from an information processing device and displayed on the video display device, the image display method includes processes of: receiving the image data from the information processing device; displaying a video received from the information processing device; and transmitting a display completion notification to the information processing device in response to the video having been displayed.

In an image display method, according to the present invention, in which image data is transmitted from an information processing device and displayed on a video display device, the image display method includes processes of: acquiring, by the information processing device, an image to be displayed from the image data that is transmitted to the video display device; storing, by the information processing device, the acquired image in a storage; transmitting, by the information processing device, the image data to the video display device; receiving, by the video display device, the image data from the information processing device; displaying, by the video display device, a video based on the image data received from the information processing device; transmitting, by the video display device, a display completion notification to the information processing device in response to the video having been displayed; and in case that the display completion notification is received, reading, by the information processing device, an image corresponding to the received display completion notification from the storage and displaying the image.

In a program, according to the present invention, to be executed by an information processing device when image data is transmitted from the information processing device and displayed on a video display device, the program includes steps of: acquiring a video to be displayed from the image data that is transmitted to the video display device; storing the acquired video in a storage; transmitting the image data to the video display device; and reading, in case that a display completion notification transmitted from the video display device in response to the video having been displayed is received, the video corresponding to the received display completion notification from the storage and displaying the video.

### Advantageous Effects of Invention

According to the present invention, a video corresponding to a video displayed on a video display device is displayed superimposed on a part of a display of an information processing device. Thereby, it is possible to ascertain content of the video displayed by the video display device at an information processing device side.

### BRIEF DESCRIPTION OF DRAWINGS

FIG. 1 is a schematic configuration diagram of a video display system according to an embodiment of the present invention.

FIG. 2 is an explanatory diagram of a display of an information processing device according to the embodiment of the present invention.

FIG. 3 is a block diagram showing a configuration of the information processing device and a video display device in the video display system according to the embodiment of the present invention.

FIG. 4 is a flowchart showing a process of the information processing device according to the embodiment of the present invention.

FIG. 5 is a flowchart showing a process of the video display device according to the embodiment of the present invention.

FIG. 6A is an explanatory diagram of an example of an image display process of the video display system according to the embodiment of the present invention.

FIG. 6B is an explanatory diagram of an example of an image display process of the video display system according to the embodiment of the present invention.

FIG. 6C is an explanatory diagram of an example of an image display process of the video display system according to the embodiment of the present invention.

FIG. 6D is an explanatory diagram of an example of an image display process of the video display system according to the embodiment of the present invention.

FIG. 7A is an explanatory diagram of another example of the image display process of the video display system according to the embodiment of the present invention.

FIG. 7B is an explanatory diagram of another example of the image display process of the video display system according to the embodiment of the present invention.

FIG. 7C is an explanatory diagram of another example of the image display process of the video display system according to the embodiment of the present invention.

FIG. 7D is an explanatory diagram of another example of the image display process of the video display system according to the embodiment of the present invention.

FIG. 8 is an explanatory diagram of a process when a video to be displayed is continuously switched in the image display system according to the embodiment of the present invention.

FIG. 9 is a schematic block diagram showing a basic configuration of the information processing device according to the present invention.

### DESCRIPTION OF EMBODIMENTS

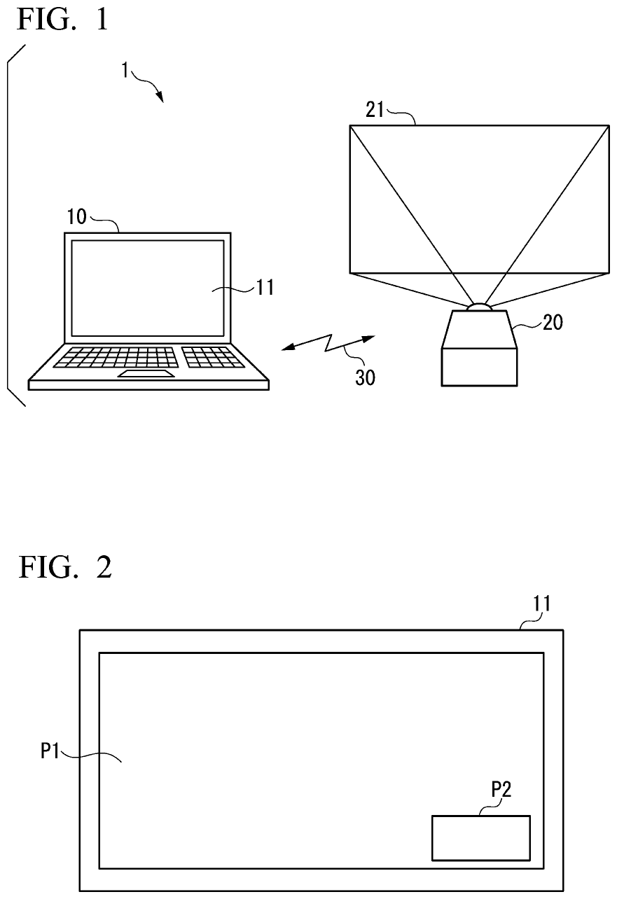

Hereinafter, embodiments of the present invention will be described with reference to the drawings. FIG. 1 is a schematic configuration diagram of a video display system 1 according to an embodiment of the present invention.

As shown in FIG. 1, the video display system 1 according to the embodiment of the present invention includes an information processing device 10 and a video display device 20. The information processing device 10 and the video display device 20 are connected via, for example, a wireless local area network (LAN) 30. As the information processing device 10, a personal computer (PC) is used. The information processing device 10 includes a display 11. The video display device 20 is, for example, a projector, and displays a video on a screen 21.

FIG. 2 is an explanatory diagram of the display 11 of the information processing device 10 according to the embodiment of the present invention. As shown in FIG. 2, the display 11 includes a main image area P1 and a sub-image area P2. The sub-image area P2 is an area superimposed and displayed on a part of the main image area P1.

The video display system 1 according to the embodiment of the present invention shown in FIG. 1 is used, for example, for giving a presentation. When the presentation is given, an application program of the information processing device 10 is activated. Image data is transmitted from the information processing device 10 to the video display device 20 via the wireless LAN 30. At this time, the information processing device 10 captures a video to be transmitted to the video display device 20, scales the video at the optimum resolution for displaying the video on the video display device 20, and transmits the video to the video display device 20 via the wireless LAN network 30 after an encoding process for optimizing an amount of information suitable for image transmission is performed. After receiving image data, the video display device 20 decodes and restores the image data and displays the video on the screen 21 through a video display process. Also, the video based on the image data transmitted to the video display device 20 is displayed in the main image area P1 of the display 11 of the information processing device 10.

Here, it is assumed that a presenter has switched the video for use in a presentation. At this time, the video of the main image area P1 of the display 11 of the information processing device 10 is immediately updated with a new video. On the other hand, the video projected on the screen 21 of the video display device 20 is updated after a processing time period of a series of flows. Thus, content of the video displayed on the main image area P1 of the display 11 of the information processing device 10 may not match content of the video displayed on the screen 21 of the video display device 20.

Therefore, in the present embodiment, the video display device 20 further transmits a display completion notification to the information processing device 10 when the video display process is completed. If the display completion notification is received, the information processing device 10 reduces the captured video and superimposes and displays the captured video on the sub-image area P2 of the display 11. Thereby, a video corresponding to the video displayed on the screen 21 of the video display device 20 is displayed in the sub-image area P2 of the display 11 of the information processing device 10. The presenter giving the presentation can be aware of the content of the video displayed on the screen 21 of the video display device 20 by checking the video displayed in the sub-image area P2 of the display 11. Thereby, the presenter can give an explanation according to the video that the audience is viewing.

Although the PC is used as the information processing device 10 in the present example, the information processing device 10 is not limited to the PC. Although the projector is used as the video display device 20 in the present example, the video display device 20 is not limited to the projector. Although the information processing device 10 and the video display device 20 are connected by the wireless LAN 30 in the present example, a connection between the information processing device 10 and the video display device 20 is not limited to the wireless LAN.

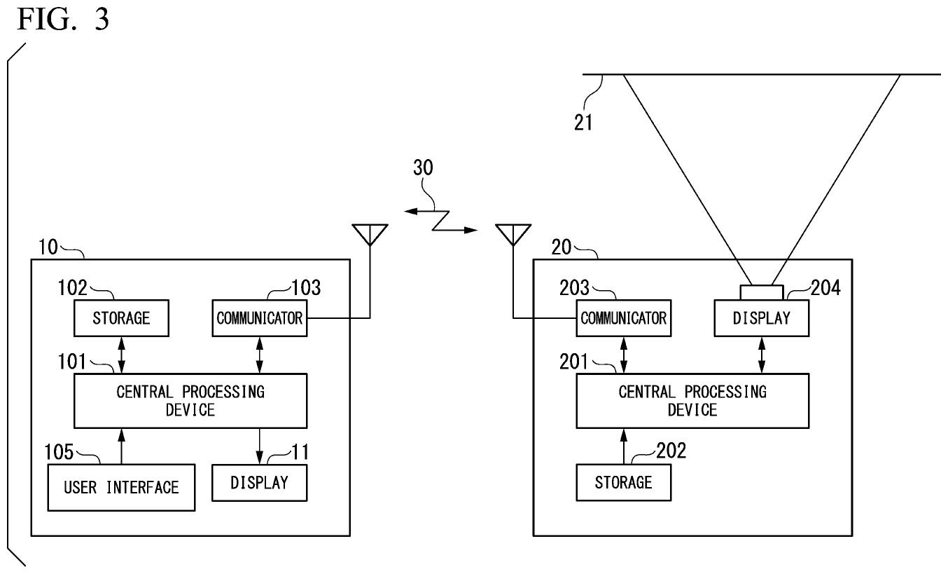

FIG. 3 is a block diagram showing a configuration of the information processing device 10 and the video display device 20 in the video display system 1 according to the embodiment of the present invention. As shown in FIG. 3, the information processing device 10 includes a central processing device 101, a storage 102, a communicator 103, a display 11, and a user interface 105.

The central processing device 101 includes a central processing unit (CPU) or the like and performs a process on the basis of a program stored in the storage 102. In the present embodiment, the central processing device 101 executes a presentation application program and performs a process of displaying a desired video in the main image area P1 of the display 11. Also, the central processing device 101 performs a process of capturing the video to be represented on the display 11, scaling and encoding image data of the video to be represented on the display 11 in response to the resolution of the video display device 20, and transmitting the scaled and encoded image data to the video display device 20. Also, the term “capture” means that a single image is captured and saved. Also, if the central processing device 101 receives the display completion notification from the video display device 20, the central processing device 101 performs a process of reducing the captured video and displaying the reduced captured video in the sub-image area P2 of the display 11. The central processing device 101 functions as an acquisitioner that acquires (captures) a video from image data that is transmitted to the video display device 20. Also, the central processing device 101 functions as an image processor that reduces a display size of the acquired image.

The storage 102 includes various types of memories such as a read only memory (ROM), a random access read/write memory (RAM), a hard disk drive (HDD), and a solid-state drive (SSD). The storage 102 includes a storage medium, for example, an HDD, a flash memory, an electrically erasable programmable read only memory (EEPROM), a RAM, a ROM, or any combination of these storage media. In the present embodiment, the storage 102 stores an operating system and an application program for a presentation. Also, the storage 102 captures and saves a video to be displayed. Also, the storage 102 is used as a temporary storage area at the time of scaling or encoding of image data.

The communicator 103 transmits/receives data to/from the communicator 203 of the video display device 20 via the wireless LAN. In the present embodiment, the communicator 103 transmits image data to the video display device 20. Also, the communicator 103 receives a display completion notification transmitted from the video display device 20 in response to the completion of the display of the video signal.

The display 11 has a liquid crystal drive circuit and a liquid crystal display panel, and the liquid crystal drive circuit generates a drive signal for driving the liquid crystal display panel in response to a video signal output from the central processing device 101, and outputs the drive signal to the liquid crystal display panel. The liquid crystal display panel displays a video based on the image data by driving an element of each pixel in response to the drive signal output from the liquid crystal drive circuit.

The user interface 105 includes a keyboard, a mouse, and the like. The user interface 105 receives an input operation of a user and outputs the input operation to the central processing device 101. The central processing device 101 performs various types of processes in response to an input from the user interface 105.

The video display device 20 includes a central processing device 201, a storage 202, a communicator 203, and a display 204.

The central processing device 201 includes a CPU and the like and performs a process on the basis of a program stored in the storage 202. In the present embodiment, the central processing device 201 performs a process of decoding the image data received from the information processing device 10 and displaying the decoded image data on the screen 21 by the display 204. Also, when a process of displaying the image data received from the information processing device 10 is completed, the central processing device 201 performs a process of transmitting a display completion notification to the information processing device 10.

The storage 202 includes various types of memories such as a ROM, a RAM, an HDD, and an SSD. The storage 202 includes a storage medium, for example, an HDD, a flash memory, an EEPROM, a RAM, a ROM, or any combination of these storage media. In the present embodiment, the storage 202 is used as a temporary storage area when the resolution conversion is performed on the image data or the image data is decoded.

The communicator 203 transmits/receives data to/from the communicator 103 of the information processing device 10 via the wireless LAN. In the present embodiment, the communicator 203 receives the image data from the information processing device 10. Also, the communicator 203 transmits the display completion notification to the information processing device 10.

The display 204 includes a liquid crystal drive circuit, a liquid crystal panel, a projection lamp, and a projection lens, and constitutes a liquid crystal projector. The liquid crystal drive circuit generates a drive signal for driving the liquid crystal panel in response to a video signal output from the central processing device 201, and outputs the drive signal to the liquid crystal panel. The liquid crystal panel drives an element of each pixel in response to the drive signal output from the liquid crystal drive circuit. The projection lamp radiates projection light to the liquid crystal panel. The projection lens is irradiated with the light from the projection lamp and the projection light transmitted via the liquid crystal panel is concentrated on the screen 21.

Also, the display 204 is not limited to the configuration of the liquid crystal projector and may be a projector having another configuration such as a digital light processing (DLP) projector. Also, the display 204 is not limited to the projector and may be another type of display such as a liquid crystal display.

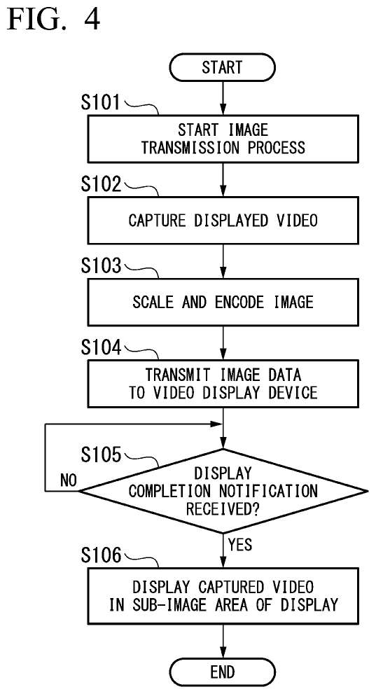

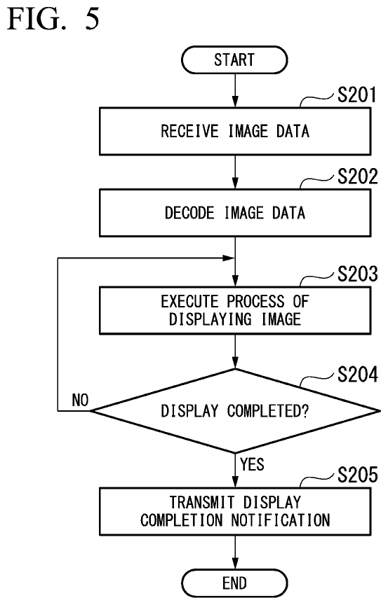

FIG. 4 is a flowchart showing a process of the information processing device 10 according to the embodiment of the present invention. FIG. 5 is a flowchart showing a process of the video display device 20 according to the embodiment of the present invention.

(Step S101) In FIG. 4, the central processing device 101 of the information processing device 10 starts a process of transmitting an image represented on the display 11 and moves the process to step S102.

(Step S102) The central processing device 101 captures a video displayed on the display 11, stores the video in the storage 102, and moves the process to step S103.

(Step S103) The central processing device 101 performs a scaling process and an encoding process on image data of the video captured in the storage 102 and moves the process to step S104.

(Step S104) The central processing device 101 transmits the image data subjected to the scaling process and the encoding process to the video display device 20 and moves the process to step S105.

(Step S105) The central processing device 101 determines whether or not the communicator 103 has received a display completion notification from the video display device 20. If the central processing device 101 has not received the display completion notification (step S105: No), the central processing device 101 returns the process to step S105 and waits until the display completion notification is received. When the display completion notification has been received (step S105: Yes), the process proceeds to step S106.

If the information processing device 10 has not received the display completion notification (step S105: No), the information processing device 10 is in a standby state until the display completion notification is received.

The image data from the information processing device 10 is received at the video display device 20 side. When the information processing device 10 transmits the image data to the video display device 20 in step S104, the process proceeds to step S201 in FIG. 5.

(Step S201) In FIG. 5, the central processing device 201 of the video display device 20 moves the process to step S202 if the communicator 203 receives the image data from the information processing device 10.

(Step S202) The central processing device 201 decodes the image data transmitted from the information processing device 10 and moves the process to step S203.

(Step S203) The central processing device 201 executes a process for displaying the image data transmitted from the information processing device 10 on the display 204 and moves the process to step S204.

(Step S204) The central processing device 201 determines whether or not the display process has been completed, iteratively performs a process of returning the process to step S203 and displaying the image data on the display 204 if the display process has not been completed (step S204: No), and moves the process to step S205 if the display process has been completed (step S204: Yes).

(Step S205) When the display process has been completed, the central processing device 201 performs a process of transmitting the display completion notification to the information processing device 10.

As shown in FIG. 4, if the image data is transmitted to the video display device 20 at the video display device 20 side in step S104, the display completion notification from the video display device 20 is awaited in step S105. If a transmission completion notification is transmitted from the video display device 20 to the information processing device 10 in step S105, the central processing device 101 of the information processing device 10 determines that the display completion notification has been received in step S105.

(Step S106) When the central processing device 101 receives the display completion notification from the video display device 20, the process is completed by reading the video captured in step S102 from the storage 102, reducing a display size of the video, and superimposing and displaying the video of the reduced display size on the sub-image area P2 of the display 11.

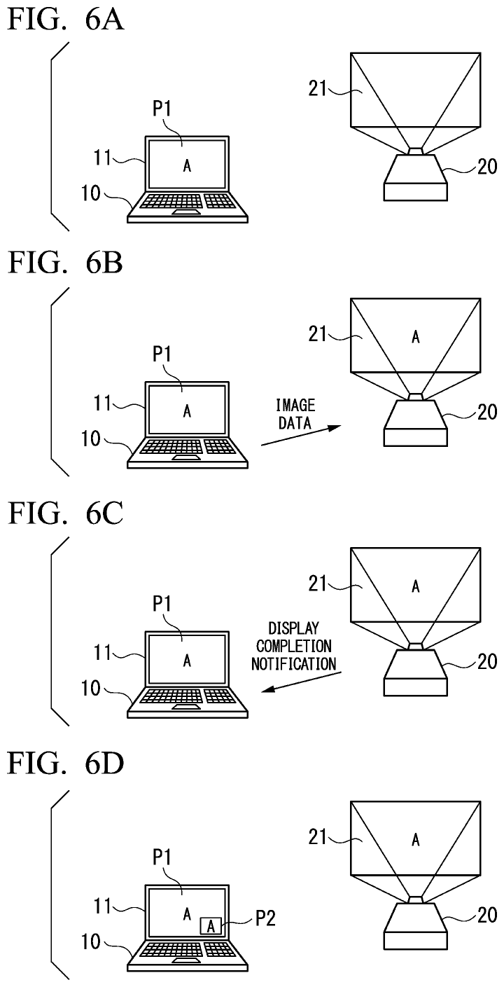

FIGS. 6A to 6D are explanatory diagrams of an example of the image display process in the video display system according to the embodiment of the present invention. Here, it is assumed that a video of the letter “A” is displayed on the display 11 of the information processing device 10 and the screen 21 of the video display device 20. If an instruction for displaying the letter “A” is given to the information processing device 10 by operating the user interface 105 of the information processing device 10, the video of the letter “A” is displayed immediately in the main image area P1 of the display 11 as shown in FIG. 6A. At this time, no image is displayed on the screen 21 of the video display device 20.

The video of the letter “A” displayed on the display 11 is captured at the information processing device 10 side as shown in step S102 in FIG. 4 and the scaling process and the encoding process are performed on a transmission image as shown in step S103. As shown in step S104, image data of the transmission image is transmitted from the information processing device 10 to the video display device 20. Thereby, as shown in FIG. 6B, image data of the video of the letter “A” is encoded and transmitted from the information processing device 10 to the video display device 20.

As shown in step S201 in FIG. 5, the image data from the information processing device 10 is received at the video display device 20 side. As shown in steps S202 to S204 in FIG. 5, if the image data from the information processing device 10 is received at the video display device 20 side, a process of decoding the image data and displaying an image thereof on the screen 21 is performed. Thereby, as shown in FIG. 6B, the video of the letter “A” is displayed on the screen 21.

As shown in steps S204 and S205 in FIG. 5, when the display of the image on the screen 21 is completed, the video display device 20 transmits a display completion notification to the information processing device 10 as shown in FIG. 6C.

As shown in step S105 in FIG. 4, the information processing device 10 is waiting for the display completion notification from the video display device 20. As shown in steps S105 and S106 in FIG. 4, if the information processing device 10 receives the display completion notification, the captured image is displayed in the sub-image area P2 of the display 11. Thereby, as shown in FIG. 6D, the video of the letter “A” is displayed in the sub-image area P2 of the display 11. The presenter operating the information processing device 10 can recognize that the video of the letter “A” has been displayed on the video display device 20 by viewing the video of the letter “A” in the sub-image area P2.

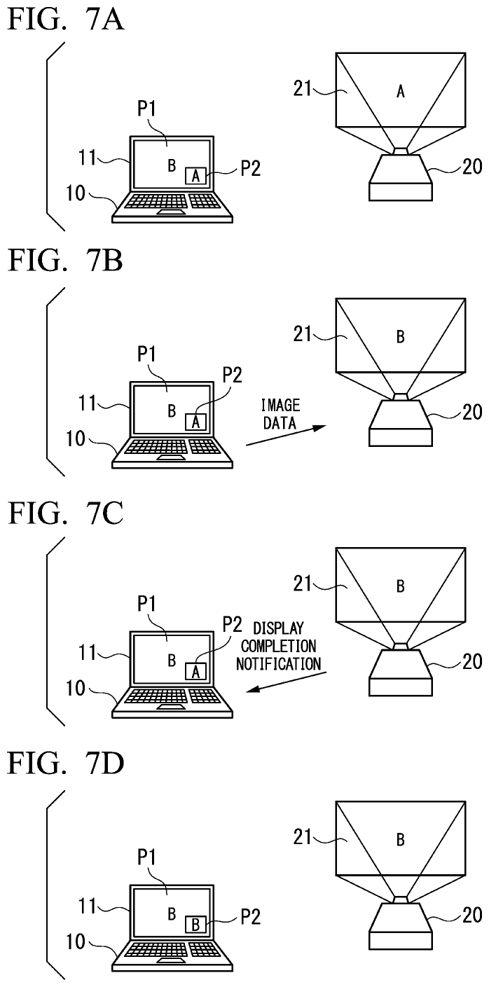

FIGS. 7A to 7D are explanatory diagrams of other examples of the image display process in the video display system according to the embodiment of the present invention. Here, it is assumed that the video of the letter “A” has been previously displayed on the display 11 of the information processing device 10 and the screen 21 of the video display device 20. It is assumed that the information processing device 10 has been instructed to perform a changeover from the letter “A” to the letter “B” by operating the user interface 105 of the information processing device 10.

As shown in FIG. 7A, the display of the main image area P1 of the display 11 is immediately switched from the video of the letter “A” to the video of the letter “B.” At this time, the image on the screen 21 of the video display device 20 remains the video of the letter “A.” Also, the display of the sub-image area P2 of the display 11 remains the video of the letter “A.”

The video of the letter “B” displayed on the display 11 is captured at the information processing device 10 side as shown in step S102 in FIG. 4 and the scaling process and the encoding process are performed on a transmission image as shown in step S103. As shown in step S104, image data of the above image is transmitted from the information processing device 10 to the video display device 20. Thereby, as shown in FIG. 7B, image data of the video of the letter “B” is encoded and transmitted from the information processing device 10 to the video display device 20.

As shown in step S201 in FIG. 5, the image data from the information processing device 10 is received at the video display device 20 side. As shown in steps S202 to S204 in FIG. 5, if the image data from the information processing device 10 is received at the video display device 20 side, a process of decoding the image data and displaying an image thereof on the screen 21 is performed. Thereby, as shown in FIG. 7B, the video of the letter “B” is displayed on the screen 21.

As shown in steps S204 and S205 in FIG. 5, if the display of the image on the screen 21 is completed, the video display device 20 transmits a display completion notification to the information processing device 10 as shown in FIG. 7C.

As shown in step S105 in FIG. 4, the information processing device 10 is waiting for the display completion notification from the video display device 20. As shown in steps S105 and S106 in FIG. 4, when the information processing device 10 receives the display completion notification, the captured image is displayed in the sub-image area P2 of the display 11. Thereby, as shown in FIG. 7D, the video of the sub-image area P2 of the display 11 is switched from the video of the letter “A” to the video of the letter “B.” The presenter operating the information processing device 10 can recognize that the video of the letter “B” has been displayed on the video display device 20 by viewing the video of the letter “B” in the sub-image area P2.

As described above, according to the processing of steps S101 to S106 and the processing of steps S201 to S205 described above, the presenter viewing the display 11 of the information processing device 10 can be aware of a video displayed on the screen 21 of the video display device 20 at that time from a displayed image of the sub-image area P2.

Also, the image displayed superimposed on the sub-image area P2 of the information processing device 10 in step S106 may be excluded from a target to be captured in step S102. In this case, the video displayed on the display 11 is regarded as a still image and a subsequent process is performed using the captured video.

Also, because the video superimposed on the sub-image area P2 in step S106 has been captured at a timing of step S102, the information processing device 10 may execute a process of providing a video to be superimposed on the sub-image area P2 in parallel with processing being executed by the video display device 20 in steps S202 to S204.

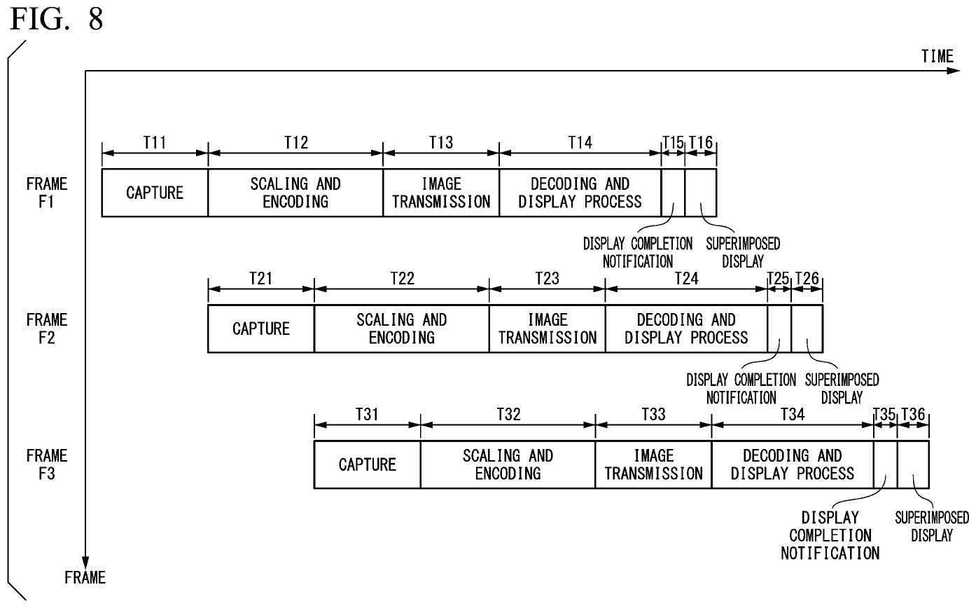

FIG. 8 is an explanatory diagram of a process of a case in which a video to be displayed is continuously switched in the video display system according to the embodiment of the present invention. As shown in FIG. 8, in a video of a first frame F1, at the information processing device 10 side, the video is captured for a period T11 and scaled and encoded for a period T12 and image data corresponding to the video from the information processing device 10 to the video display device 20 is transmitted for a period T13. At the video display device 20 side, a process of decoding and displaying the image data is performed for a period T14 and a display completion notification is transmitted from the video display device 20 to the information processing device 10 for a period T15. When the display completion notification is received, the information processing device 10 displays the video captured for the period T16 in the sub-image area P2.

In videos of frames F2, F3, and the like subsequent to the above frame, the video is captured at a predetermined timing in parallel with the processing of the frames up to that point. That is, for the frame F2, immediately after the period T11 for which the video of the frame F1 is captured ends, the video is captured for a period T21 and the video is scaled and encoded for a period T22, and image data is transmitted from the information processing device 10 to the video display device 20 for a period T23. Furthermore, for the next frame F3, immediately after the period T21 for which the video of the frame F2 is captured ends, the video is captured for a period T31 and the video is scaled and encoded for a period T32, and image data is transmitted from the information processing device 10 to the video display device 20 for a period T33.

The video display device 20 performs a process of decoding the frames F1, F2, and F3 and the like for the periods T14, T24, and T34 and the like and transmits a display completion notification to the information processing device 10 for the periods T15, T25, and T35, and the like. When identification information for identifying the video is included in the display completion notification, it is possible to determine which video frame has been displayed at the information processing device 10 side. At the information processing device 10 side, videos of the frames F1, F2, and F3 and the like are displayed in the sub-image area P2 of the display 11 for the periods T16, T26, and T36, and the like.

Although a case in which image transmission is performed between the information processing device 10 and the video display device 20 has been described as an example in the above-described embodiment, the present invention can be used to ascertain how a video transmitted by a user is represented on a display device that the other party is viewing in a case in which video communication is performed between information processing devices using another information processing device instead of the video display device 20, a case in which a conference is held using a video conferencing system, or the like.

Also, the image to be transmitted does not necessarily have to be a captured image of a video that is displayed by the information processing device 10. For example, a usage method of capturing only an image of a presentation material separately from a video displayed on the information processing device 10, transmitting the captured image to the video display device 207, and displaying the image on the video display device 207 is also conceivable.

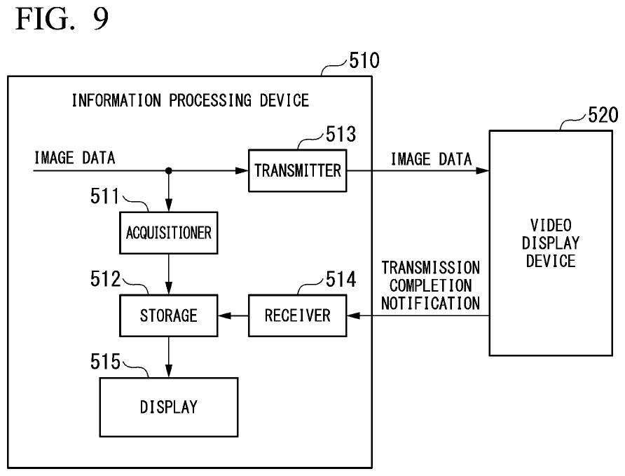

FIG. 9 is a schematic block diagram showing a basic configuration of the information processing device according to the present invention. The information processing device 510 according to the present invention has a basic configuration of an acquisitioner 511, a storage 512, a transmitter 513, a receiver 514, and a display 515.

The acquisitioner 511 acquires a video to be displayed from image data that is transmitted to the video display device 520. The storage 512 stores the acquired video. The transmitter 513 transmits the image data to the video display device 520. The receiver 514 receives a display completion notification transmitted from the video display device 520 in response to the video having been displayed. The display 515 reads the video corresponding to the display completion notification received by the receiver 514 from the storage 512 and displays the video.

All or a part of the video display system 1 according to the above-described embodiment may be configured to be implemented in a computer. In this case, functions of the video display system 1 may be implemented by recording a program for implementing the functions on a computer-readable recording medium and causing a computer system to read and execute the program recorded on the recording medium. Also, the “computer system” described here is assumed to include an operating system (OS) and hardware such as peripheral devices. Also, the “computer-readable recording medium” refers to a flexible disk, a magneto-optical disc, a read only memory (ROM), a portable medium such as a compact disc (CD)-ROM, or a storage device such as a hard disk embedded in the computer system. Further, the “computer-readable recording medium” may include a computer-readable recording medium for dynamically retaining the program for a short time period as in a communication line when the program is transmitted via a network such as the Internet or a communication circuit such as a telephone circuit and a computer-readable recording medium for retaining the program for a given time period as in a volatile memory inside the computer system including a server and a client when the program is transmitted. Also, the above-described program may be a program for implementing some of the above-described functions. Further, the above-described program may be a program capable of implementing the above-described function in combination with a program already recorded on the computer system or may be a program implemented using a programmable logic device such as a field programmable gate array (FPGA).

Although embodiments of the present disclosure have been described above with reference to the drawings, specific configurations are not limited to the embodiments and other designs and the like may also be included without departing from the scope of the present disclosure.

### REFERENCE SIGNS LIST

10 Information processing device
11 Display
20 Video display device
21 Screen
101, 201 Central processing device
102, 202 Storage
103, 203 Communicator
204 Display
510 Information processing device
511 Acquisitioner
512 Storage
513 Transmitter
514 Receiver
515 Display

1. An information processing device comprising:
an acquisitioner configured to acquire a video to be displayed from image data that is transmitted to a video display device;
a storage configured to store the acquired video;
a transmitter configured to transmit the image data to the video display device;
a receiver configured to receive a display completion notification transmitted from the video display device in response to the video having been displayed; and
a display configured to read the video corresponding to the display completion notification received by the receiver from the storage and display the video.

2. The information processing device according to claim 1, wherein the display displays the video to be transmitted to the video display device and displays the video corresponding to the display completion notification.

3. The information processing device according to claim 1, wherein the acquisitioner acquires the video from the image data before scaling based on resolution at which the video display device performs a display process is performed.

4. The information processing device according to claim 1, the information processing device comprising an image processor configured to reduce a display size of the acquired video,
wherein the display displays the video having been reduced in response to the display completion notification having been received.

5. The information processing device according to claim 1,
wherein the acquisitioner acquires the video at each determined timing,
wherein the receiver receives the display completion notification comprising identification information for identifying the video of a video signal displayed on the video display device, and
wherein the display reads the video corresponding to the identification information from the storage and displays the video.

6. The information processing device according to claim 1,
wherein the video display device comprises:
a receiver configured to receive the image data transmitted from the transmitter of the information processing device;
a display configured to display the video based on the image data received from the information processing device; and
a transmitter configured to transmit the display completion notification to the information processing device in response to the video having been displayed, and
wherein the receiver of the information processing device receives the display completion notification transmitted from the transmitter of the video display device.

7. A video display device comprising:
a receiver configured to receive image data from an information processing device;
a display configured to display a video based on the image data received from the information processing device; and
a transmitter configured to transmit a display completion notification to the information processing device in response to the video having been displayed.

8. The video display device according to claim 7,
wherein the information processing device comprises:
an acquisitioner configured to acquire the video to be displayed from the image data that is transmitted to the video display device;
a storage configured to store the acquired video;
a transmitter configured to transmit the image data to the video display device;
a receiver configured to receive the display completion notification transmitted from the video display device in response to the video having been displayed; and
a display configured to read the video corresponding to the display completion notification received by the receiver from the storage and displays the video,
wherein the receiver of the video display device receives the image data transmitted from the transmitter of the information processing device, and
wherein the transmitter of the video display device transmits the display completion notification to the receiver of the information processing device.

9. (canceled)

10. An image display method to be performed by an information processing device when image data is transmitted from the information processing device and displayed on a video display device, the image display method comprising:
acquiring a video to be displayed from the image data that is transmitted to the video display device;
storing the acquired video in a storage;
transmitting the image data to the video display device; and
reading, in case that a display completion notification transmitted from the video display device in response to the video having been displayed is received, the video corresponding to the received display completion notification from the storage and displaying the video.

11. (canceled)

12. (canceled)

13. (canceled)
